(19) United States
(12) Patent Application Publication
(10) Pub. No.: US 2005/0063186 A1
(43) Pub. Date: Mar. 24, 2005

(54) Light source apparatus, analyzer using the same, and method for controlling light source apparatus

(75) Inventor: Ryutaro Oda, Kyoto-shi (JP)

Correspondence Address: RANKIN, HILL, PORTER & CLARK LLP, 4080 ERIE STREET, WILLOUGHBY, OH, 44094-7836, US

(73) Assignee: SHIMADZU CORPORATION, Kyoto-shi (JP)

(21) Appl. No.: 10/940,255

(22) Filed: Sep. 14, 2004

(30) Foreign Application Priority Data
Sep. 24, 2003 (JP) 2003-330837

(51) Int. Cl. F21V 29/00

(52) U.S. Cl. 362/294; 362/373

(57) ABSTRACT

A cooling fan for air-cooling a lamp housing is installed near to the lamp housing in which the lamp is accommodated. This cooling fan is adapted to suck out heated air surrounding the lamp housing directly to the outside of an apparatus. A time taken by the temperature of the lamp housing, which rises due to heat generated by the lamp, to reach a stable temperature is preliminarily set in a fan control portion. The fan control portion controls the cooling fan in such a way as to stop until this time elapses. Alternatively, the fan control portion initially operates the cooling fan at a rotating speed that is lower than a normal operation rotating speed, and thereafter causes the fan to start rotating at the normal operation rotating speed.

### BACKGROUND OF THE INVENTION

1. Field of the Invention

The present invention relates to various kinds of analyzers, for example, a spectrophotometer, a fluorophotometer, and a refractometer, and to a light source apparatus for use therein.

2. Description of the Related Art

Hitherto, a discharge lamp, such as a deuterium lamp, and a tungsten lamp have been used as a light source for an analyzer, for example, a spectrophotometer, a fluorophotometer, or a refractometer. In these light sources, most of input electric power is converted into heat. Thus, the light sources itself is heated. As an emission time elapses, the temperature of the light source rises. When the temperature thereof excessively rises, the light source itself is damaged. Therefore, it is necessary to cool the light source. Further, the amount of light radiation from the light source varies due to this change of the temperature thereof. Thus, it is also necessary to take a countermeasure to prevent the amount of light radiation of the light source from changing due to change in the temperature of the light source, which is caused when ambient temperature changes.

The countermeasure to prevent the amount of light radiation of the light source from changing is, for example, a light source for a spectrophotometer for a liquid chromatograph, which is shown in FIG. 2. In FIG. 2, reference numeral 1 designates a light source. Light radiated from the light source is projected onto a spectrophotometer 4 through a mirror 2. In this case, variation in the amount of light radiated from the light source 1 causes a detection value at a detector varies and is a cause for obstructing high-sensitivity measurement. Thus, to prevent the detection value at the detector 10 from varying with environmental temperature, the light source 1 is accommodated in a lamp housing 3 having a certain high degree of heat capacity. Then, heat is radiated by air-cooling the outside of the housing 3 through the use of a cooling fan 8 at a constant air volume. This impedes the transmission of change in the environmental temperature to the surroundings of the light source 1.

In the case of the aforementioned method, when the heat capacity of the lamp housing 3 is large, it takes long time until the temperature of the surroundings of the light source 1 and that of the light source 1 become stable since the light source 1 turns on and starts generating heat. Thus, the stabilization of the amount of light radiated by the light source 1 takes long time. Consequently, this method needs long time to stabilize the detection value of the detector 10.

The inventor of the present invention has proposed the technique of providing a controller for controlling the fan, and a temperature sensor for measuring the internal temperature of the lamp housing in a casing, and of controlling the fan in such a way as to stop or operate at a low number of revolutions until the internal temperature of the lamp housing reaches certain temperature to thereby stabilize the temperature of the lamp and the temperature of the surroundings thereof (see JP-A-2000-74821).

### SUMMARY OF THE INVENTION

An object of the invention is to provide a light source apparatus and a method for controlling the same, and an analyzer using the light source apparatus, which can achieve the stabilization of the amount of light radiated by the light source in a short time by a method that is different from the method disclosed in the JP-A-2000-74821.

According to the invention, there is provided a light source apparatus comprising:
a lamp serving as a light source;
a lamp housing in which said lamp is accommodated;
a fan for air-cooling the lamp housing; and
a control unit for controlling said fan,
wherein said control unit controls said fan so that, in a predetermined time after said lamp starts emitting light, said fan stops or operates at a rotating speed, which is lower than a normal operation rotating speed, and thereafter, said fan operates at the set normal operation rotating speed.

In an analyzer that analyzes a sample by irradiating light, which is radiated from a light source unit, onto a sample, and detecting light from the sample, the light source apparatus is used as the light source unit.

According to the invention, in a predetermined time after the lamp starts emitting light, the inside of the lamp housing is not cooled. Alternatively, the fan is operated in a state, in which a cooling efficiency is relatively low, to thereby make the temperature of the inside of the lamp housing closer to a stable temperature.

The “predetermined time” is a time taken to stabilize the temperature of the lamp housing and that of the surroundings of the lamp, which is preliminarily measured or obtained by being computed according to the amount of heat generated by the lamp, the heat capacity of the lamp housing and the amount of heat radiated from the lamp housing. Information representing the “predetermined time” can be stored in the apparatus.

In the predetermined time since the lamp starts emitting light, the fan is operated in a low-rotating-speed state, or maintained in a stopped state. Thus, the temperature of the surroundings of the lamp can rise in a short time and reach the stable temperature. Further, after the predetermined time elapses, the fan is rotated at the number of revolutions, which is employed in a normally operation, thereby to maintain the temperature of the surroundings of the lamp at a constant value. Consequently, the amount of light radiation from the lamp can be stabilized. Thus, the apparatus of the invention simply controls the fan according to the preset time. Consequently, the configuration thereof is simple.

### BRIEF DESCRIPTION OF THE DRAWINGS

FIG. 1 is a diagram schematically showing the configuration of an embodiment obtained by applying a light source apparatus of the invention to an ultraviolet spectrophotometer; and

FIG. 2 is a diagram schematically showing the configuration of a related-art apparatus.

### DETAILED DESCRIPTION OF THE INVENTION

Hereinafter, an embodiment of the invention is described.

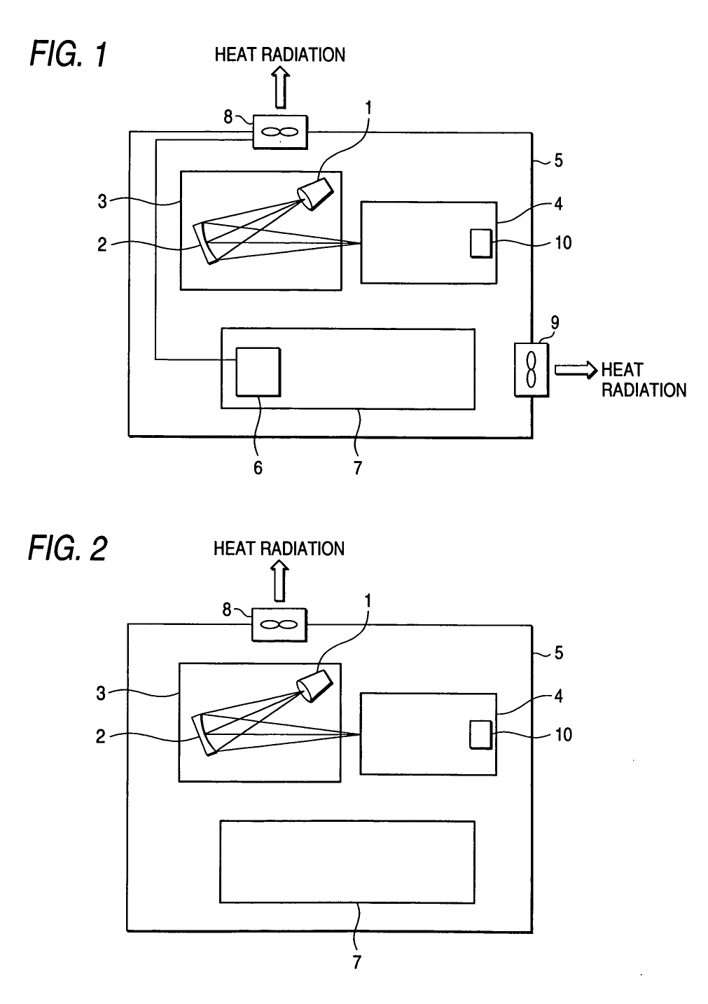

FIG. 1 is a diagram schematically showing the configuration of the embodiment obtained by applying the light source apparatus of the invention to an ultraviolet spectrophotometer.

A deuterium lamp 1 is used as a light source. Light outputted from this lamp 1 is converged to an inlet slit (not shown) of a spectroscopic portion 4 by a mirror 2. After the light is spectrally resolved in the spectroscopic portion 4, the resolved light is irradiated onto a sample cell (not shown). Then, light transmitted by the sample is detected by a detector 10 to thereby measure absorbance.

A cooling fan 8 for air-cooling the lamp housing 3 is installed near to the lamp housing 3 in which the lamp 1 is accommodated. This cooling fan 8 is installed in an exhaust port of a casing 5, and adapted to suck out heated air surrounding the lamp housing 3 directly to the outside of an apparatus.

Further, this cooling fan 8 is connected to a fan control portion 6 incorporated into an electric system portion 7. This fan control portion 8 controls the number of revolutions of the fan 8 to thereby adjust the temperature of the surroundings of the lamp housing 3. In this fan control portion 6, data representing the relation between a time, which elapses since the lamp 1 turns on, and the number of revolutions of the cooling fan 8 is set. The control portion 6 is adapted to control according to the set data.

In addition, a lighting circuit for the lamp 1, a control portion for the spectroscopic portion, a signal processing portion, a power supply portion, and so on are provided in the electric system portion 7.

Reference numeral 9 designates a cooling fan for cooling heat generating portions other than the lamp 1, that is, other heat generating portions, such as the electric system portion 7. This cooling fan 9 is operated at a constant speed during power-on and performs cooling by discharging radiated heat to the casing 5.

Although the temperature of the lamp housing 3 gradually rises due to heat generated by the deuterium lamp 1 the after the deuterium lamp 1 starts turning on, the temperature of the lamp housing 3 is lower than the temperature in a stabilized state for a while. Thus, the cooling fan 8 is stopped in a while after the lamp 1 turns on. Alternatively, the cooling fan 8 is operated at a low rotating speed in a while. Thus, heat radiation from the lamp housing 3 is suppressed. Then, the temperature of the lamp housing 3 is made to reach a stable temperature in a short time by utilizing heat generated by the deuterium lamp 1. A time taken by the temperature of the lamp housing 3, which rises due to heat generated by the deuterium lamp 1, to reach the stable temperature is preliminarily set in the fan control portion 6. When this time elapses, the fan control portion 6 causes the cooling fan 8 to start rotating at a normal operation rotating speed. Alternatively, the control portion 6 controls the fan 8 in such a way as to increase the rotating speed thereof up to the normal operation rotating speed thereby to increase an air volume of air for cooling the lamp housing 3 and also increase a heat radiation amount so as to maintain the temperature of the lamp housing 3 at a constant value.

The time required to stabilize the temperature of the lamp 1 and the temperature of the surroundings thereof by heating the lamp housing 3 by heat, which is generated from the lamp 1 after the lamp 1 turns on, is determined by the amount of heat generated by the lamp 1, the heat capacity of the lamp housing 3 and the heat radiated by the lamp housing 3, and can be set to be substantially constant. Therefore, the time required to stabilize the temperature of the lamp 1 and the temperature of the surroundings thereof is set at a constant time in the fan control portion 6. In a constant time after the lamp turns on, the cooling fan 8 is stopped or operated at a low rotating speed. Thus, the temperature of the lamp 1 and that of the surroundings thereof can quickly be raised and stabilized, so that an output of the analyzer can be stabilized in a short time.

A position, at which the cooling fan 8 is installed, is not limited to that shown in the figure. Moreover, the analyzer may have no casing 5. The cooling fan 8 may be installed at any position, as long as the fan 8 can carry on the cooing function thereof at the position.

Although the apparatus having the cooling fan 9 has been described in the foregoing description of the embodiment, the invention can also be applied to an apparatus, which does not have the cooling fan 9.

The invention is not limited to the ultraviolet spectrophotometer described in the description of the embodiment. The invention can be applied to analyzers, such as a fluorophotometer, and a refractive index detector, which need the stability of light outputted by the light source.

The light source apparatus of the invention and the analyzer using this light source can be utilized for optically analyzing a sample in the fields of chemistry, biochemistry, medical services, and the like.

1. A light source apparatus comprising:
a lamp serving as a light source;
a lamp housing in which said lamp is accommodated;
a fan for air-cooling the lamp housing; and
a control unit for controlling said fan,
wherein said control unit controls said fan so that, in a predetermined time after said lamp starts emitting light, said fan stops or operates at a rotating speed, which is lower than a normal operation rotating speed, and thereafter, said fan operates at the set normal operation rotating speed.

2. The light source apparatus according to claim 1, wherein said predetermined time is determined by the amount of heat generated by the lamp, the heat capacity of the lamp housing and the heat radiated by the lamp housing.

3. An analyzer for analyzing a sample by irradiating light radiated from a light source unit onto the sample and detecting light from the sample, comprising:
said light source apparatus according to claim 1 as said light source unit.

4. A method for controlling a light source apparatus having a lamp serving as a light source, a lamp housing in which said lamp is accommodated, and a fan for air-cooling the lamp housing, the method comprising:
controlling said fan so that, in a predetermined time after said lamp starts emitting light, said fan stops or operates at a rotating speed, which is lower than a normal operation rotating speed, and thereafter, said fan operates at the set normal operation rotating speed.

5. The method according to claim 4, wherein said predetermined time is determined by the amount of heat generated by the lamp, the heat capacity of the lamp housing and the heat radiated by the lamp housing.
